(19) United States
(12) Patent Application Publication
(10) Pub. No.: US 2025/0042378 A1
(43) Pub. Date: Feb. 6, 2025

(54) BRAKE SYSTEM

(71) Applicant: ADVICS CO., LTD., Kariya-shi (JP)

(72) Inventor: Shun TSUKAMOTO, Kariya-shi (JP)

(73) Assignee: ADVICS CO., LTD., Kariya-shi (JP)

(21) Appl. No.: 18/836,127

(22) PCT Filed: Mar. 8, 2023
(86) PCT No.: PCT/JP2023/008898

§ 371 Date: Aug. 6, 2024

(30) Foreign Application Priority Data
Mar. 8, 2022 (JP) 2022-035074

(51) Int. Cl. B60T 13/58

(52) U.S. Cl. CPC B60T 13/586; B60T 2270/604

(57) ABSTRACT

A brake system includes electric braking devices. Each of the electric braking devices includes an electric motor. In the brake system, it is determined whether regenerative power is generated by the electric motors, and when it is determined that regenerative power is generated by any one of the electric motors, an electric motor other than the electric motor determined as generating regenerative power is driven so that a power consumption amount of the other electric motor is increased.

### TECHNICAL FIELD

The present disclosure relates to a brake system to be applied to a vehicle.

### BACKGROUND ART

PTL 1 discloses a brake system in which, of regenerative power generated by a main motor that applies a regenerative braking force to a vehicle, surplus power that cannot be stored in a power storage unit of the vehicle is consumed by a sub motor different from the main motor.

### CITATION LIST

### Patent Literature

PTL 1: JP2006-333549A

### BRIEF SUMMARY

### Technical Problem

As the brake system, there is a system including an electric braking device provided on a wheel. In such a system, regenerative power may be generated by an electric motor provided in the electric braking device. The electric motor of the electric braking device corresponds to the sub motor in the brake system disclosed in PTL 1. An object of the present disclosure is to appropriately consume regenerative power generated by an electric motor of an electric braking device.

### Solution to Problem

An example of a brake system for solving the above problems is applied to a vehicle including a first wheel and a second wheel as wheels. The brake system includes a first electric braking device configured to apply a braking force to the first wheel and a second electric braking device configured to apply a braking force to the second wheel. The first electric braking device and the second electric braking device apply a braking force to the wheel by bringing a friction portion into contact with a friction-receiving portion, and each include an actuator configured to transition an operating state of the electric braking device between a contact state in which the friction portion is in contact with the friction-receiving portion and a separated state in which the friction portion is separated from the friction-receiving portion. A first electric motor that is a power source of the actuator of the first electric braking device and a second electric motor that is a power source of the actuator of the second electric braking device are connected to a common power supply circuit. The brake system includes a determination unit configured to determine whether regenerative power is generated by the first electric motor, and a control unit configured to increase a power consumption amount of the second electric motor when the determination unit determines that regenerative power is generated by the first electric motor.

Since the first electric motor and the second electric motor are connected to a common power supply circuit, regenerative power generated by the first electric motor can be supplied to the second electric motor via the power supply circuit. Therefore, in the brake system, when it is determined that regenerative power is generated by the first electric motor, the power consumption amount of the second electric motor is increased. Accordingly, at least a part of the regenerative power generated by the first electric motor can be consumed by the second electric motor. Therefore, in the brake system, regenerative power generated by the electric motor of the first electric braking device can be appropriately consumed.

An example of a brake system for solving the above problems is applied to a vehicle including three or more wheels. The brake system includes three or more electric braking devices corresponding to the three or more wheels. The three or more electric braking devices apply a braking force to the wheel by bringing a friction portion into contact with a friction-receiving portion, and each include an actuator configured to transition an operating state of the electric braking device between a contact state in which the friction portion is in contact with the friction-receiving portion and a separated state in which the friction portion is separated from the friction-receiving portion. An electric motor that is a power source of the three or more actuators is connected to a common power supply circuit. The brake system includes a determination unit configured to determine whether regenerative power is generated by at least one of the three or more electric motors, a selection unit configured to select a power consumption motor that is the electric motor consuming regenerative power generated by a power generation motor that is the electric motor determined by the determination unit as generating regenerative power, from among the electric motors other than the power generation motor based on an operating state of the electric braking device including the electric motor other than the power generation motor, and a control unit configured to increase the power consumption amount of the power consumption motor selected by the selection unit when the determination unit determines that regenerative power is generated by any one of the three or more electric motors.

Since the three or more electric motors are connected to the common power supply circuit, regenerative power generated by any one of the three or more electric motors can be supplied to electric motors other than the electric motor generating the regenerative power via the power supply circuit. Therefore, in the brake system, when there is a power generation motor that is an electric motor determined as generating regenerative power among three or more electric motors, a power consumption motor is selected from among electric motors other than the power generation motor, based on operating states of the other electric braking devices other than the electric braking device including the power generation motor. The power consumption motor is driven to increase the power consumption amount of the power consumption motor. Accordingly, when regenerative power is generated by any one of the three or more electric motors, regenerative power generated by the power generation motor can be consumed by the other electric motors. Therefore, in the brake system, regenerative power generated by the electric motor of the electric braking device can be appropriately consumed.

### BRIEF DESCRIPTION OF DRAWINGS

FIG. 1 is a configuration diagram schematically illustrating a vehicle including a brake system according to a first embodiment.

FIG. 2 is a block diagram illustrating a control configuration of the brake system according to the first embodiment.

FIG. 3 is a graph illustrating rotation coordinates of vector control.

FIG. 4 is a flowchart illustrating power consumption amount increase request processing executed by an execution unit of an electric braking device in the brake system according to the first embodiment.

FIG. 5 is a flowchart illustrating power consumption amount increase processing executed by the execution unit of the electric braking device in the brake system according to the first embodiment.

FIG. 6 is a configuration diagram schematically illustrating a vehicle including a brake system according to a second embodiment.

FIG. 7 is a block diagram illustrating a control configuration of the brake system according to the second embodiment.

FIG. 8 is a flowchart illustrating power consumption amount increase request processing executed by an execution unit of an integrated control device in the brake system according to the second embodiment.

### DESCRIPTION OF EMBODIMENTS

### First Embodiment

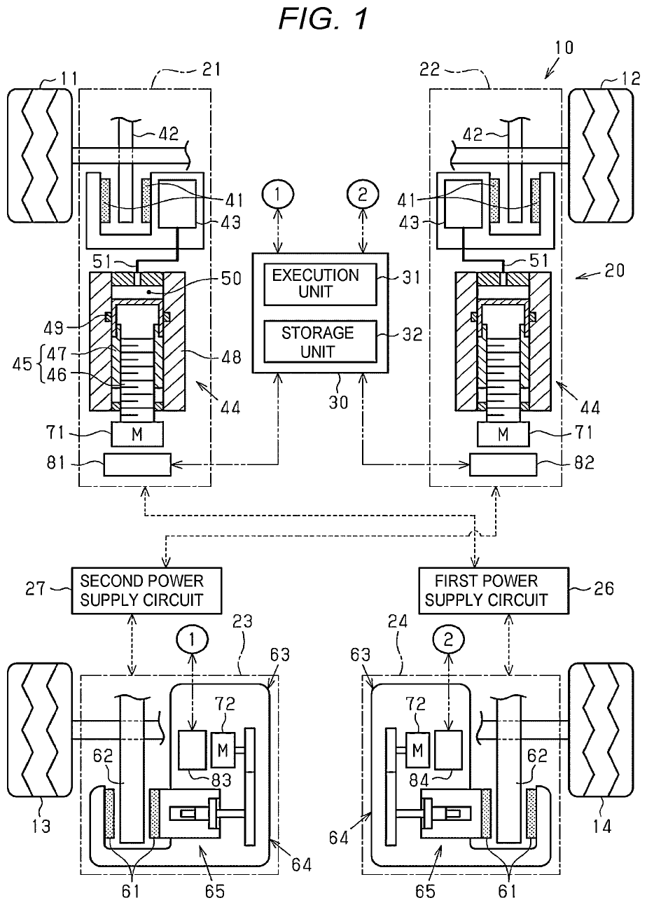

Hereinafter, a first embodiment of a brake system will be described with reference to FIGS. 1 to 5.

As illustrated in FIG. 1, a vehicle 10 includes a plurality of wheels and a brake system 20 that adjusts a braking force to be applied to the plurality of wheels. The vehicle 10 includes a left front wheel 11, a right front wheel 12, a left rear wheel 13, and a right rear wheel 14 as the wheels.

### <Brake System>

The brake system 20 includes a plurality of electric braking devices 21, 22, 23 and 24 provided individually for the plurality of wheels 11 to 14, a plurality of power supply circuits 26 and 27, and an integrated control device 30. Among the plurality of electric braking devices, the electric braking devices 21 and 22 that apply a braking force to the front wheels 11 and 12 are referred to as “front wheel electric braking devices 21 and 22”, and the electric braking devices 23 and 24 that apply a braking force to the rear wheels 13 and 14 are referred to as “rear wheel electric braking devices 23 and 24”.

Of the plurality of power supply circuits 26 and 27, the first power supply circuit 26 supplies power to the front wheel electric braking device 21 that applies a braking force to the left front wheel 11 and the rear wheel electric braking device 24 that applies a braking force to the right rear wheel 14. The second power supply circuit 27 supplies power to the front wheel electric braking device 22 that applies a braking force to the right front wheel 12 and the rear wheel electric braking device 23 that applies a braking force to the left rear wheel 13.

The integrated control device 30 includes an execution unit 31 and a storage unit 32. For example, the execution unit 31 is a CPU. The storage unit 32 stores various control programs to be executed by the execution unit 31. The execution unit 31 executes the control program to derive a braking force command value, which is a command value of the braking force to be applied to the wheels 11 to 14 by the electric braking devices 21 to 24. The execution unit 31 operates the plurality of electric braking devices 21 to 24 by transmitting the braking force command value to control units 81, 82, 83, and 84 of the plurality of electric braking devices 21 to 24 described later.

### <Front Wheel Electric Braking Device>

In the embodiment, the front wheel electric braking devices 21 and 22 are electric braking devices of a wet type. Specifically, each of the front wheel electric braking devices 21 and 22 includes a friction portion 41, a friction-receiving portion 42, a wheel cylinder 43, an electric cylinder 44, an electric motor 71, and a control unit. The control unit of the front wheel electric braking device 21 for the left front wheel 11 is set as the “control unit 81”, and the control unit of the front wheel electric braking device 22 for the right front wheel 12 is set as the “control unit 82”.

Since the friction-receiving portion 42 rotates integrally with the front wheels 11 and 12, a braking force is applied to the front wheels 11 and 12 by bringing the friction portion 41 into contact with the friction-receiving portion 42. When no hydraulic pressure is generated in the wheel cylinder 43, the friction portion 41 is separated from the friction-receiving portion 42. When a hydraulic pressure is generated in the wheel cylinder 43, the friction portion 41 comes into contact with the friction-receiving portion 42, that is, the friction portion 41 is pressed against the friction-receiving portion 42. As the hydraulic pressure of the wheel cylinder 43 increases, a force of pressing the friction portion 41 against the friction-receiving portion 42 increases, and thus the braking force applied to the front wheels 11 and 12 increases.

The electric cylinder 44 includes a transmission mechanism 45, a cylinder 48, and a piston 49. The transmission mechanism 45 includes a rotation portion 46 that rotates in synchronization with the electric motor 71, and a linear motion portion 47 that linearly moves in a direction corresponding to the rotation of the rotation portion 46. The piston 49 is disposed inside the cylinder 48. When the linear motion portion 47 linearly moves in accordance with the rotation of the rotation portion 46, the piston 49 linearly moves inside the cylinder 48. A fluid chamber 50 is defined within the cylinder 48 by the piston 49, and the fluid chamber 50 is connected to the wheel cylinder 43 via a fluid path 51. When the piston 49 linearly moves in a direction of reducing a volume of the fluid chamber 50, a brake fluid in the fluid chamber 50 is supplied to the wheel cylinder 43 via the fluid path 51, so that the hydraulic pressure of the wheel cylinder 43 increases. That is, the electric cylinder 44 and the wheel cylinder 43 can cause operating states of the front wheel electric braking devices 21 and 22 to transition between a contact state in which the friction portion 41 is in contact with the friction-receiving portion 42 and a separated state in which the friction portion 41 is separated from the friction-receiving portion 42. In the front wheel electric braking devices 21 and 22, the electric cylinder 44 and the wheel cylinder 43 correspond to an “actuator” that uses the electric motor 71 as a power source.

The control units 81 and 82 control the electric motor 71 based on the braking force command value received from the integrated control device 30. Specifically, the control units 81 and 82 drive the electric motor 71 such that the braking force applied to the front wheels 11 and 12 increases as a braking force command value increases. A specific configuration of the control units 81 and 82 will be described later.

In the front wheel electric braking devices 21 and 22, regenerative power may be generated by the electric motor 71. The regenerative power generated by the electric motor 71 is supplied to the power supply circuit. That is, the regenerative power generated by the electric motor 71 of the front wheel electric braking device 21 is supplied to the first power supply circuit 26. The regenerative power generated by the electric motor 71 of the front wheel electric braking device 22 is supplied to the second power supply circuit 27.

The electric motor 71 may generate regenerative power when a rotation direction of the electric motor 71 is opposite to a torque direction thereof. Such a state may occur when a control mode of the front wheel electric braking devices 21 and 22 is switched. The control mode of the electric braking device includes a decrease mode of decreasing the braking force applied to the wheels, a holding mode of holding the braking force, and an increase mode of increasing the braking force. The control mode switching by which regenerative power is generated includes switching from the decrease mode to the holding mode, switching from the decrease mode to the increase mode, switching from the increase mode to the holding mode, and switching from the increase mode to the decrease mode. The regenerative power is generated when power generated accompanying the operation of the electric motor 71 exceeds power consumption due to a copper loss of the electric motor 71.

### <Rear Wheel Electric Braking Device>

In the embodiment, the rear wheel electric braking devices 23 and 24 are electric braking devices of a dry type. Specifically, each of the rear wheel electric braking devices 23 and 24 includes a friction portion 61, a friction-receiving portion 62, an actuator 63, an electric motor 72, and a control unit. The control unit of the rear wheel electric braking device 23 for the left rear wheel 13 is set as the “control unit 83”, and the control unit of the rear wheel electric braking device 24 for the right rear wheel 14 is set as the “control unit 84”.

Since the friction-receiving portion 62 rotates integrally with the rear wheels 13 and 14, a braking force is applied to the rear wheels 13 and 14 by bringing the friction portion 61 into contact with the friction-receiving portion 62. By increasing a force of pressing the friction portion 61 against the friction-receiving portion 62, the braking force applied to the rear wheels 13 and 14 is increased.

The actuator 63 operates with the electric motor 72 as a power source. Specifically, the actuator 63 operates to shift operating states of the rear wheel electric braking devices 23 and 24 between a contact state and a separated state. The actuator 63 includes a speed reduction mechanism 64 and a linear motion conversion mechanism 65. The speed reduction mechanism 64 reduces a speed of a rotational motion of the electric motor 72 and outputs the rotational motion reduced in speed to the linear motion conversion mechanism 65. The linear motion conversion mechanism 65 converts the rotational motion input from the speed reduction mechanism 64 into a linear motion and outputs the linear motion to the friction portion 61. Therefore, in the rear wheel electric braking devices 23 and 24, when the electric motor 72 is driven, an output torque of the electric motor 72 is transmitted to the friction portion 61 via the actuator 63. Accordingly, the friction portion 61 approaches the friction-receiving portion 62, or the friction portion 61 separates from the friction-receiving portion 62. When the friction portion 61 comes into contact with the friction-receiving portion 62, a frictional force is applied to the rear wheels 13 and 14.

The control units 83 and 84 control the electric motor 72 based on the braking force command value received from the integrated control device 30. Specifically, the control units 83 and 84 drive the electric motor 72 such that the braking force applied to the rear wheels 13 and 14 increases as a braking force command value increases. A specific configuration of the control units 83 and 84 will be described later.

In the rear wheel electric braking devices 23 and 24, regenerative power may be generated by the electric motor 72. The regenerative power generated by the electric motor 72 is supplied to the power supply circuit. That is, the regenerative power generated by the electric motor 72 of the rear wheel electric braking device 23 is supplied to the second power supply circuit 27. The regenerative power generated by the electric motor 72 of the rear wheel electric braking device 24 is supplied to the first power supply circuit 26.

The electric motor 72 may generate regenerative power when a control mode of the rear wheel electric braking devices 23 and 24 is switched. Since the situation in which the regenerative power is generated by the electric motor 72 is the same as the situation in which the regenerative power is generated by the electric motor 71, a detailed description is omitted here.

### <Control System for Brake System>

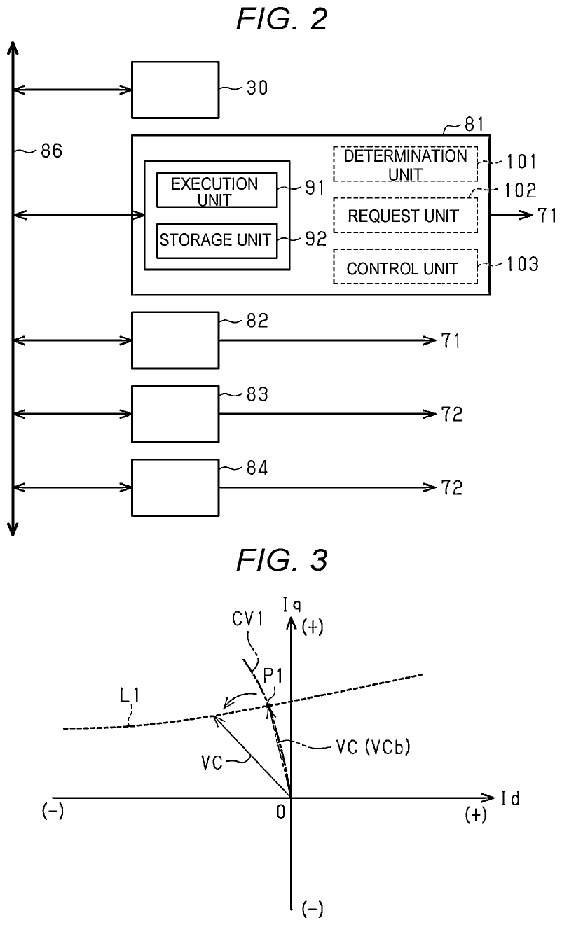

FIG. 2 is a block diagram illustrating the integrated control device 30, the plurality of control units 81 to 84, and a CAN bus 86 provided in the vehicle 10. The integrated control device 30 and the plurality of control units 81 to 84 are connected to the CAN bus 86. Therefore, the integrated control device 30 can exchange information with the plurality of control units 81 to 84 via the CAN bus 86. The plurality of control units 81 to 84 can exchange information with each other via the CAN bus 86.

The plurality of control units 81 to 84 each include an execution unit 91 and a storage unit 92. For example, the execution unit 91 is a CPU. The storage unit 92 stores various control programs to be executed by the execution unit 91.

Each of the plurality of execution units 91 functions as a determination unit 101, a request unit 102, and a control unit 103 by executing a control program.

The determination unit 101 determines whether regenerative power is generated by the electric motor associated therewith. The electric motor associated with the determination unit 101 of the control unit 81 is the electric motor 71 of the front wheel electric braking device 21. The electric motor associated with the determination unit 101 of the control unit 82 is the electric motor 71 of the front wheel electric braking device 22. The electric motor associated with the determination unit 101 of the control unit 83 is the electric motor 72 of the rear wheel electric braking device 23. The electric motor associated with the determination unit 101 of the control unit 84 is the electric motor 72 of the rear wheel electric braking device 24.

In the embodiment, when the control mode of the electric braking device associated with the determination unit 101 is switched, the determination unit 101 determines that regenerative power is generated by the electric motor of the electric braking device. Specifically, when any one of the following conditions (A1), (A2), (A3), and (A4) is satisfied, the determination unit 101 determines that regenerative power is generated by the electric motor.
(A1) The control mode of the electric braking device is switched from the decrease mode to the holding mode.
(A2) The control mode of the electric braking device is switched from the decrease mode to the increase mode.
(A3) The control mode of the electric braking device is switched from the increase mode to the holding mode.
(A4) The control mode of the electric braking device is switched from the increase mode to the decrease mode.

When the determination unit 101 determines that regenerative power is generated by the electric motor, the request unit 102 requests the control unit 103, which is associated with another electric motor than the electric motor associated with the request unit 102, to increase a power consumption amount of the other electric motor. When the electric motor associated with the request unit 102 is defined as a “first electric motor” and the electric motor other than the first electric motor connected to the same power supply circuit as the first electric motor is defined as a “second electric motor”, the other electric motor referred to here corresponds to the second electric motor. Therefore, the request unit 102 of the control unit 81 requests the control unit 103 of the control unit 84 to increase the power consumption amount of the electric motor 72 of the rear wheel electric braking device 24. The request unit 102 of the control unit 82 requests the control unit 103 of the control unit 83 to increase the power consumption amount of the electric motor 72 of the rear wheel electric braking device 23. The request unit 102 of the control unit 83 requests the control unit 103 of the control unit 82 to increase the power consumption amount of the electric motor 71 of the front wheel electric braking device 22. The request unit 102 of the control unit 84 requests the control unit 103 of the control unit 81 to increase the power consumption amount of the electric motor 71 of the front wheel electric braking device 21.

The control unit 103 controls the electric motor associated therewith based on the braking force command value received from the integrated control device 30. In the embodiment, the control unit 103 controls the electric motor by vector control.

FIG. 3 is a graph illustrating rotation coordinates of vector control. In the rotation coordinates of vector control, a d-axis is a control axis extending in the direction of a flux axis of permanent magnets of the electric motor, and a q-axis is a control axis extending in the direction of a torque. In the vector control, the control unit 103 drives the electric motor by adjusting a d-axis current Id that is a current component in the direction of the d-axis and a q-axis current Iq that is a current component in the direction of the q-axis. Specifically, the control unit 103 derives a torque command value, which is a command value of an output torque of the electric motor, based on the braking force command value, and derives the d-axis current Id and the q-axis current Iq based on the torque command value. The control unit 103 controls the current flowing through each coil of the electric motor based on the d-axis current Id and the q-axis current Iq, thereby driving the electric motor.

In FIG. 3, a maximum torque curve CV1 is indicated by a one-dot chain line, and an equal torque line L1 of the torque command value is indicated by a broken line. When a current vector VC indicated by the d-axis current Id and the q-axis current Iq indicates an intersection point P1 of the maximum torque curve CV1 and the equal torque line L1 in the rotation coordinates, the output torque of the electric motor can be set as the torque command value while minimizing the power consumption amount of the electric motor. In other words, when the current vector VC indicates a point other than the intersection point P1 on the equal torque line L1, the power consumption amount of the electric motor is larger as compared with the case where the current vector VC indicates the intersection point P1.

As indicated by a two-dot chain line in FIG. 3, the current vector VC indicating the intersection point P1 is referred to as a “reference current vector VCb”. The d-axis current Id of the reference current vector VCb is referred to as a “reference d-axis current Idb”, and the q-axis current Iq of the reference current vector VCb is referred to as a “reference q-axis current Iqb”.

When the determination unit 101 associated with the first electric motor determines that regenerative power is generated by the first electric motor, the control unit 103 increases the power consumption amount of the electric motor (second electric motor) associated therewith. That is, when the determination unit 101 associated with the first electric motor determines that regenerative power is generated by the first electric motor, the request unit 102 associated with the first electric motor requests the control unit 103 associated with the second electric motor to increase the power consumption amount of the second electric motor. Therefore, the control unit 103 associated with the second electric motor increases the power consumption amount of the second electric motor when requested, by the request unit 102 associated with the first electric motor, to increase the power consumption amount of the second electric motor. For example, when the control unit 103 of the control unit 81 is requested, by the request unit 102 of the control unit 84, to increase the power consumption amount of the electric motor 71 of the front wheel electric braking device 21, the control unit 103 increases the power consumption amount of the electric motor 71 of the front wheel electric braking device 21. In this example, the electric motor 71 of the front wheel electric braking device 21 corresponds to the “first electric motor”, and the electric motor 72 of the rear wheel electric braking device 24 corresponds to the “second electric motor”.

In the embodiment, when the operating state of the electric braking device corresponding to the control unit 103 is the contact state, the control unit 103 increases the power consumption amount of the electric motor by performing d-axis current increase control of increasing the d-axis current Id. Specifically, the control unit 103 derives the d-axis current Id and the q-axis current Iq so that an absolute value of the d-axis current Id is larger than an absolute value of the reference d-axis current Idb in the d-axis current increase control. For example, the control unit 103 derives the d-axis current Id and the q-axis current Iq of the current vector VC indicated by a solid line in FIG. 3. The power consumption amount of the electric motor in a case where the control unit 103 performs the d-axis current increase control is larger than the power consumption amount of the electric motor in a case where the control unit 103 does not perform the d-axis current increase control.

On the other hand, when the operating state of the electric braking device corresponding to the control unit 103 is the separated state, the control unit 103 increases the power consumption amount of the electric motor by performing electric motor forced drive control of driving the electric motor in a range in which the operating state of the electric braking device is maintained in the separated state. Specifically, the control unit 103 drives the electric motor such that the friction portion approaches the friction-receiving portion or the friction portion separates from the friction-receiving portion.

### <Power Consumption Amount Increase Request Processing>

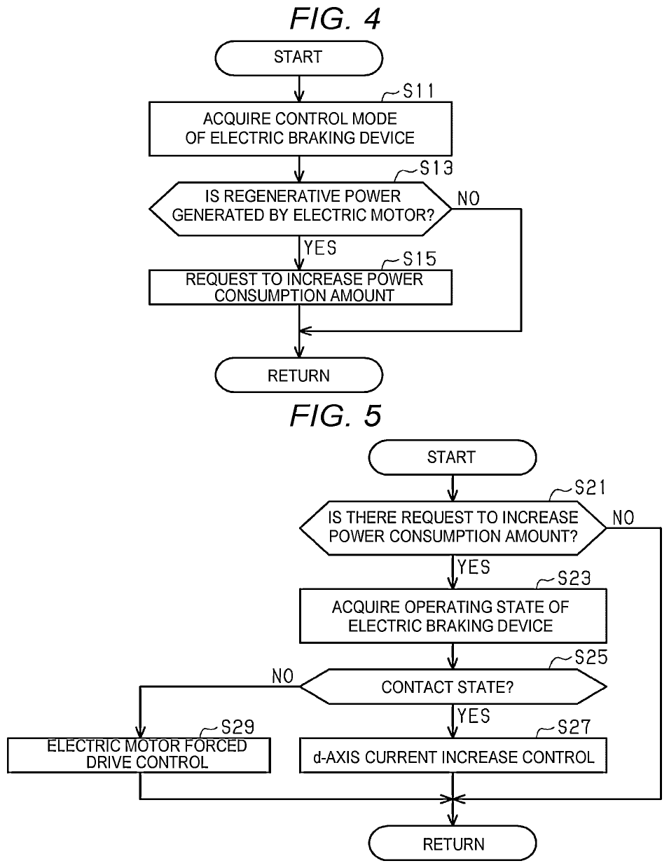

Power consumption amount increase request processing, which is a flow of processing of requesting the control unit that controls the second electric motor to increase the power consumption amount of the second electric motor, will be described with reference to FIG. 4. FIG. 4 is a flowchart illustrating the power consumption amount increase request processing. A control program corresponding to the power consumption amount increase request processing is stored in the storage unit 92 of the control units 81 to 84. The control program is repeatedly executed at predetermined intervals by the execution unit 91 when a braking force is applied to the wheel by the operation of the electric braking device.

In step S11, the execution unit 91 acquires the control mode of the electric braking device corresponding thereto. Specifically, the execution unit 91 acquires the control mode based on transition in a control variable of the electric motor (first electric motor) of the electric braking device corresponding thereto. The control variable of the electric motor is derived at predetermined intervals. Therefore, for example, the execution unit 91 acquires the decrease mode as the control mode when a latest value of the control variable is smaller than a previous value, acquires the increase mode as the control mode when the latest value of the control variable is larger than the previous value, and acquires the holding mode as the control mode when the latest value of the control variable is the same as the previous value.

In step S13, the execution unit 91 functions as the determination unit 101 to determine whether regenerative power is generated by the electric motor (first electric motor) of the electric braking device corresponding to the execution unit 91. Specifically, based on the control mode acquired in step S11 in the previous execution of the power consumption amount increase request processing and the control mode acquired in step S11 this time, the execution unit 91 determines whether any one of the above conditions (A1) to (A4) is satisfied. If it is determined that any one of the conditions (A1) to (A4) is satisfied, the execution unit 91 determines that regenerative power is generated by the electric motor. On the other hand, if it is determined that none of the conditions (A1) to (A4) is satisfied, the execution unit 91 determines that no regenerative power is generated by the electric motor. If it is determined that regenerative power is generated by the electric motor (S13: YES), the execution unit 91 proceeds to the processing in step S15. If it is determined that no regenerative power is generated (S13: NO), the execution unit 91 temporarily ends the current processing.

In step S15, the execution unit 91 functions as the request unit to request the control unit, which is corresponding to the electric motor (second electric motor) connected to the power supply circuit that is common to the electric motor (first electric motor) of the electric braking device corresponding to the execution unit 91, to increase the power consumption amount of the electric motor (second electric motor). Thereafter, the execution unit 91 ends the current processing.

### <Power Consumption Amount Increase Processing>

With reference to FIG. 5, power consumption amount increase processing, which is a flow of processing of increasing the power consumption amount of the electric motor (second electric motor), will be described. FIG. 5 is a flowchart illustrating the power consumption amount increase processing. A control program corresponding to the power consumption amount increase processing is stored in the storage unit 92 of the control units 81 to 84. The control program is repeatedly executed at predetermined intervals by the execution unit 91.

In step S21, the execution unit 91 determines whether the control unit corresponding to the other electric motor (first electric motor) requests the execution unit 91 to increase the power consumption amount of the electric motor (second electric motor) corresponding to the execution unit 91. If the execution unit 91 is requested to increase the power consumption amount of the electric motor (S21: YES), the execution unit 91 proceeds to the processing of step S23. If the execution unit 91 is not requested to increase the power consumption amount of the electric motor (S21: NO), the execution unit 91 temporarily ends the current processing.

In step S23, the execution unit 91 acquires the operating state of the electric braking device corresponding thereto. Specifically, the execution unit 91 checks whether the operating state of the electric braking device is the contact state or the separated state.

In step S25, the execution unit 91 determines whether the operating state of the electric braking device acquired in step S23 is the contact state. If the operating state is the contact state (S25: YES), the execution unit 91 proceeds to the processing of step S27, and if the operating state is the separated state (S25: NO), the execution unit 91 proceeds to the processing of step S29.

In step S27, the execution unit 91 functions as the control unit 103 to start the above-described d-axis current increase control. Thereafter, the execution unit 91 temporarily ends the current processing.

In step S29, the execution unit 91 functions as the control unit 103 to start the above-described electric motor forced drive control. Thereafter, the execution unit 91 temporarily ends the current processing.

When the d-axis current increase control or the electric motor forced drive control is started by executing the power consumption amount increase processing, the execution unit 91 ends the control after performing the control for a predetermined period.

### Operations and Effects of Embodiment

(B1) The operations and effects in a case where a braking force is applied to the rear wheels 13 and 14 by the rear wheel electric braking devices 23 and 24 based on a command from the integrated control device 30 will be described.

For example, when the control mode of the rear wheel electric braking device 24 is switched, the control unit 84 of the rear wheel electric braking device 24 determines that regenerative power is generated by the electric motor 72 of the rear wheel electric braking device 24. Since the rear wheel electric braking device 24 and the front wheel electric braking device 21 are connected to the common first power supply circuit 26 as illustrated in FIG. 1, the control unit 84 requests the control unit 81 of the front wheel electric braking device 21 to increase the power consumption amount of the electric motor 71 of the front wheel electric braking device 21.

When the control unit 81 receives the above request from the control unit 84, the electric motor 71 is driven to increase the power consumption amount of the electric motor 71 of the front wheel electric braking device 21. At this time, since the operating state of the front wheel electric braking device 21 is the contact state when a braking force is applied to the left front wheel 11 by the front wheel electric braking device 21, the control unit 81 performs the d-axis current increase control. Accordingly, the power consumption amount of the electric motor 71 is increased while restricting a variation in the output torque of the electric motor 71 of the front wheel electric braking device 21. The fact that the output torque of the electric motor 71 does not vary means that the braking force applied to the left front wheel 11 by the front wheel electric braking device 21 does not change. The regenerative power generated by the electric motor 72 of the rear wheel electric braking device 24 can be supplied to the electric motor 71 of the front wheel electric braking device 21 via the first power supply circuit 26. Therefore, by increasing the power consumption amount of the electric motor 71 of the front wheel electric braking device 21, at least a part of the regenerative power generated by the electric motor 72 of the rear wheel electric braking device 24 can be consumed by the electric motor 71 of the front wheel electric braking device 21 while restricting an increase in the braking force applied to the left front wheel 11.

On the other hand, in a case where no braking force is applied to the left front wheel 11 by the front wheel electric braking device 21 when the control unit 81 receives the above request, since the operating state of the front wheel electric braking device 21 is the separated state, the control unit 81 executes the electric motor forced drive control. In this case, the electric motor 71 of the front wheel electric braking device 21 is driven within a range in which no braking force is applied to the left front wheel 11. Therefore, at least a part of the regenerative power generated by the electric motor 72 of the rear wheel electric braking device 24 can be consumed by the electric motor 71 of the front wheel electric braking device 21 without applying a braking force to the left front wheel 11.

In this case, the rear wheel electric braking device 24 corresponds to a “first electric braking device”, and the electric motor 72 of the rear wheel electric braking device 24 corresponds to the “first electric motor”. The control unit 84 of the rear wheel electric braking device 24 corresponds to a “first control device” corresponding to the first electric braking device, and the right rear wheel 14 corresponds to a “first wheel”. The front wheel electric braking device 21 corresponds to a “second electric braking device”, and the electric motor 71 of the front wheel electric braking device 21 corresponds to the “second electric motor”. The control unit 81 of the front wheel electric braking device 21 corresponds to a “second control device” corresponding to the second electric braking device, and the left front wheel 11 corresponds to a “second wheel”.

When it is determined that regenerative power is generated by the electric motor 72 of the rear wheel electric braking device 23, the electric motor that consumes the regenerative power is the electric motor 71 of the front wheel electric braking device 22. Therefore, in this case, the rear wheel electric braking device 23 corresponds to the “first electric braking device”, and the electric motor 72 of the rear wheel electric braking device 23 corresponds to the “first electric motor”. The control unit 83 of the rear wheel electric braking device 23 corresponds to the “first control device”, and the left rear wheel 13 corresponds to the “first wheel”. The front wheel electric braking device 22 corresponds to the “second electric braking device”, and the electric motor 71 of the front wheel electric braking device 22 corresponds to the “second electric motor”. The control unit 82 of the front wheel electric braking device 22 corresponds to the “second control device”, and the right front wheel 12 corresponds to the “second wheel”.
(B2) The operations and effects in a case where a braking force is applied to the front wheels 11 and 12 by the front wheel electric braking devices 21 and 22 based on a command from the integrated control device 30 will be described.

For example, when the control mode of the front wheel electric braking device 22 is switched, the control unit 82 of the front wheel electric braking device 22 determines that regenerative power is generated by the electric motor 71 of the front wheel electric braking device 22. Since the front wheel electric braking device 22 and the rear wheel electric braking device 23 are connected to the common second power supply circuit 27 as illustrated in FIG. 1, the control unit 82 requests the control unit 83 of the rear wheel electric braking device 23 to increase the power consumption amount of the electric motor 72 of the rear wheel electric braking device 23.

When the control unit 83 receives the above request from the control unit 82, the d-axis current increase control or the electric motor forced drive control is performed to increase the power consumption amount of the electric motor 72. That is, since the operating state of the rear wheel electric braking device 23 is the contact state when a braking force is applied to the left rear wheel 13 by the rear wheel electric braking device 23, the control unit 83 performs the d-axis current increase control. On the other hand, since the operating state of the rear wheel electric braking device 23 is the separated state when no braking force is applied to the left rear wheel 13 by the rear wheel electric braking device 23, the control unit 83 executes the electric motor forced drive control. Accordingly, at least a part of the regenerative power generated by the electric motor 71 of the front wheel electric braking device 22 can be consumed by the electric motor 72 of the rear wheel electric braking device 23.

In this case, the front wheel electric braking device 22 corresponds to the “first electric braking device”, and the electric motor 71 of the front wheel electric braking device 22 corresponds to the “first electric motor”. The control unit 82 of the front wheel electric braking device 22 corresponds to the “first control device”, and the right front wheel 12 corresponds to the “first wheel”. The rear wheel electric braking device 23 corresponds to the “second electric braking device”, and the electric motor 72 of the rear wheel electric braking device 23 corresponds to the “second electric motor”. The control unit 83 of the rear wheel electric braking device 23 corresponds to the “second control device”, and the left rear wheel 13 corresponds to the “second wheel”.

When it is determined that regenerative power is generated by the electric motor 71 of the front wheel electric braking device 21, the electric motor that consumes the regenerative power is the electric motor 72 of the rear wheel electric braking device 24. Therefore, in this case, the front wheel electric braking device 21 corresponds to the “first electric braking device”, and the electric motor 71 of the front wheel electric braking device 21 corresponds to the “first electric motor”. The control unit 81 of the front wheel electric braking device 21 corresponds to the “first control device”, and the left front wheel 11 corresponds to the “first wheel”. The rear wheel electric braking device 24 corresponds to the “second electric braking device”, and the electric motor 72 of the rear wheel electric braking device 24 corresponds to the “second electric motor”. The control unit 84 of the rear wheel electric braking device 24 corresponds to the “second control device”, and the right rear wheel 14 corresponds to the “second wheel”.

In the embodiment, the following effects can be further obtained.
(1) A case where the control unit of the first electric braking device requests the control unit of the second electric braking device to increase the power consumption amount of the second electric motor after regenerative power is actually generated by the first electric motor is considered. In this case, the start of the d-axis current increase control or electric motor forced drive control for increasing the power consumption amount of the second electric motor may be delayed in response to the generation of regenerative power by the first electric motor, and there is a concern that the regenerative power generated by the first electric motor cannot be consumed by the second electric motor.

In this regard, in the embodiment, it is determined that the regenerative power is generated by the electric motor of the electric braking device in which any one of the above conditions (A1) to (A4) is satisfied. Therefore, before regenerative power is actually generated by the first electric motor, the control unit of the second electric braking device can start the d-axis current increase control or electric motor forced drive control in preparation for the second electric motor to consume the regenerative power. As a result, it is possible to restrict a delay in the start of increasing the power consumption of the second electric motor in response to the generation of the regenerative power by the first electric motor, and to allow the second electric motor to consume the regenerative power generated by the first electric motor.

### Second Embodiment

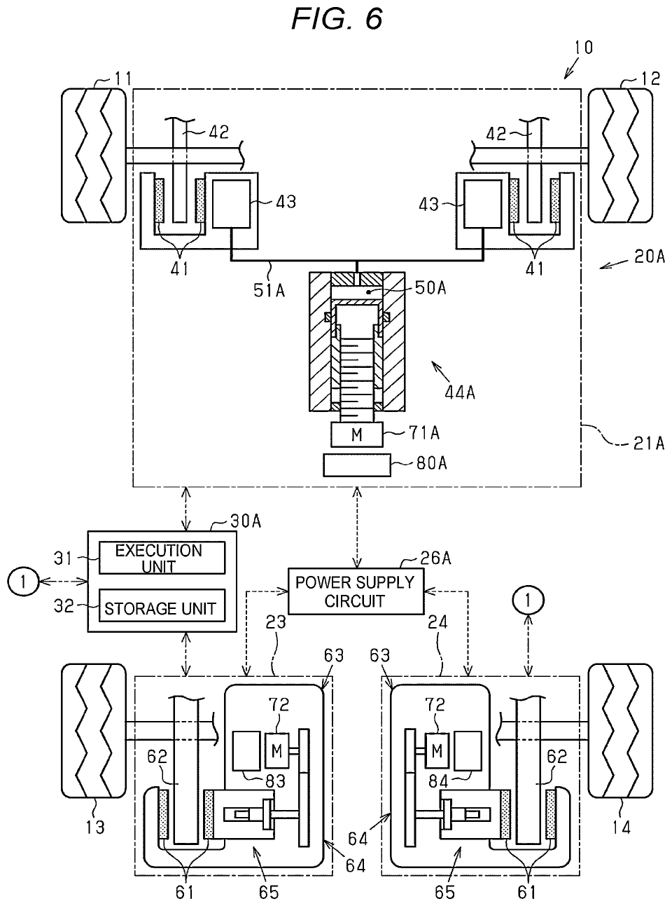

A second embodiment of the brake system will be described with reference to FIGS. 6 to 8. The second embodiment is different from the first embodiment in points that one power supply circuit is provided and a braking force can be applied to the front wheels 11 and 12 by one front wheel electric braking device, in contents of control, and the like. In the following description, portions different from those of the first embodiment are mainly described. The same members as those of the first embodiment are denoted by the same reference signs, and a repeated description thereof is omitted.

FIG. 6 is a schematic diagram illustrating a brake system 20A according to the embodiment. The brake system 20A includes a front wheel electric braking device 21A, the two rear wheel electric braking devices 23 and 24, a power supply circuit 26A, and an integrated control device 30A. The power supply circuit 26A supplies power to the plurality of rear wheel electric braking devices 23 and 24 and the front wheel electric braking device 21A.

### <Front Wheel Electric Braking Device>

The front wheel electric braking device 21A includes an electric cylinder 44A, an electric motor 71A, and a control unit 80A. The electric cylinder 44A is an electric pressurizing device that operates with the electric motor 71A as a power source. A configuration of the electric cylinder 44A is substantially the same as that of the electric cylinder 44 except that a volume of the cylinder of the electric cylinder 44A is larger than a volume of the cylinder 48 of the electric cylinder 44 described in the first embodiment, and thus a detailed description thereof is omitted. A fluid chamber 50A of the electric cylinder 44A is connected to both the wheel cylinder 43 provided at the left front wheel 11 and the wheel cylinder 43 provided at the right front wheel 12 via a fluid path 51A. Therefore, the electric cylinder 44A can adjust both a hydraulic pressure of the wheel cylinder 43 for the left front wheel 11 and a hydraulic pressure of the wheel cylinder 43 for the right front wheel 12. In the embodiment, the electric cylinder 44A, the wheel cylinder 43 for the left front wheel 11, and the wheel cylinder 43 for the right front wheel 12 correspond to an “actuator” that uses the electric motor 71A as a power source.

The control unit 80A drives the electric motor 71A based on a braking force command value received from the integrated control device 30A. A specific configuration of the control unit 80A will be described later.

### <Control System for Brake System>

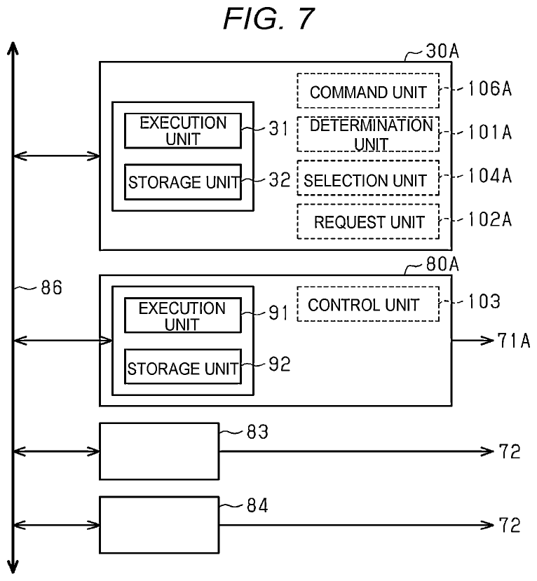

FIG. 7 is a block diagram illustrating the integrated control device 30A, the plurality of control units 80A, 83, and 84, and the CAN bus 86.

The integrated control device 30A includes the execution unit 31 and the storage unit 32. For example, the execution unit 31 is a CPU. The storage unit 32 stores various control programs to be executed by the execution unit 31.

Each of the plurality of control units 80A, 83, and 84 includes the execution unit 91 and the storage unit 92. For example, the execution unit 91 is a CPU. The storage unit 92 stores various control programs to be executed by the execution unit 91.

In the embodiment, the execution unit 31 of the integrated control device 30A functions as a command unit 106A, a determination unit 101A, a selection unit 104A, and a request unit 102A, by executing control programs stored in the storage unit 32. Each of the execution units 91 of the plurality of control units 80A, 83, and 84 functions as the control unit 103 by executing a control program stored in the storage unit 92. Since processing contents of the control unit 103 are the same as those of the first embodiment, the description of the control unit 103 is omitted here.

The command unit 106A derives a braking force command value that is a command value of a braking force to be applied to the wheels 11 to 14 by the electric braking devices 21A, 23, and 24. Specifically, the command unit 106A derives a braking force command value based on a brake operation amount of a driver of the vehicle 10 and a request from another control device. The command unit 106A transmits the derived braking force command value to the control unit 103 of the electric braking devices 21A, 23, and 24.

The determination unit 101A determines whether regenerative power is generated by the plurality of electric motors 71A and 72. Specifically, when any one of the above conditions (A1) to (A4) is satisfied in the front wheel electric braking device 21A, the determination unit 101A can determine that a control mode of the front wheel electric braking device 21A is switched, and thus determines that regenerative power is generated by the electric motor 71A. Similarly, when any one of the above conditions (A1) to (A4) is satisfied in the rear wheel electric braking device 23, the determination unit 101A determines that regenerative power is generated by the electric motor 72 of the rear wheel electric braking device 23. When any one of the above conditions (A1) to (A4) is satisfied in the rear wheel electric braking device 24, the determination unit 101A determines that regenerative power is generated by the electric motor 72 of the rear wheel electric braking device 24. In the embodiment, the electric motor that is determined by the determination unit 101A as generating regenerative power is referred to as a “power generation motor”, and the electric motor that is determined by the determination unit 101A as not generating regenerative power is referred to as a “power non-generation motor”.

When there is a power generation motor among the plurality of electric motors 71A and 72, the selection unit 104A selects a power consumption motor that is an electric motor consuming the regenerative power from among the power non-generation motors based on an operating state of the electric braking device having the power non-generation motor. For example, when the determination unit 101A determines that regenerative power is generated by the electric motor 71A of the front wheel electric braking device 21A, the selection unit 104A selects a power consumption motor that consumes the regenerative power generated by the electric motor 71A from among the plurality of electric motors 72 based on operating states of the plurality of rear wheel electric braking devices 23 and 24. In this example, the electric motor 71A of the front wheel electric braking device 21A corresponds to the “power generation motor”, and the plurality of electric motors 72 correspond to the “power non-generation motor”.

In the embodiment, when there is only one power non-generation motor, the selection unit 104A selects the power non-generation motor as the power consumption motor. On the other hand, when there are a plurality of power non-generation motors, the selection unit 104A selects at least one of the plurality of power non-generation motors as a power consumption motor. For example, when there is an electric braking device whose operating state is a separated state among electric braking devices having the power non-generation motor, the selection unit 104A selects the electric motor of the electric braking device as the power consumption motor. When there is no electric braking device whose operating state is the separated state among the electric braking devices having the power non-generation motor, the selection unit 104A selects the power consumption motor in accordance with a predetermined rule.

As the predetermined rule, for example, an electric motor having the smallest rotational speed may be selected as the power consumption motor, and an electric motor having the smallest torque command value may be selected as the power consumption motor.

The request unit 102A requests the control unit 103 corresponding to the electric motor selected as the power consumption motor by the selection unit 104A to increase the power consumption amount of the electric motor. For example, when the electric motor 72 of the rear wheel electric braking device 23 is selected as the power consumption motor by the selection unit 104A, the request unit 102A requests the control unit 103 of the rear wheel electric braking device 23 to increase the power consumption amount of the electric motor 72 of the rear wheel electric braking device 23.

### <Power Consumption Amount Increase Request Processing>

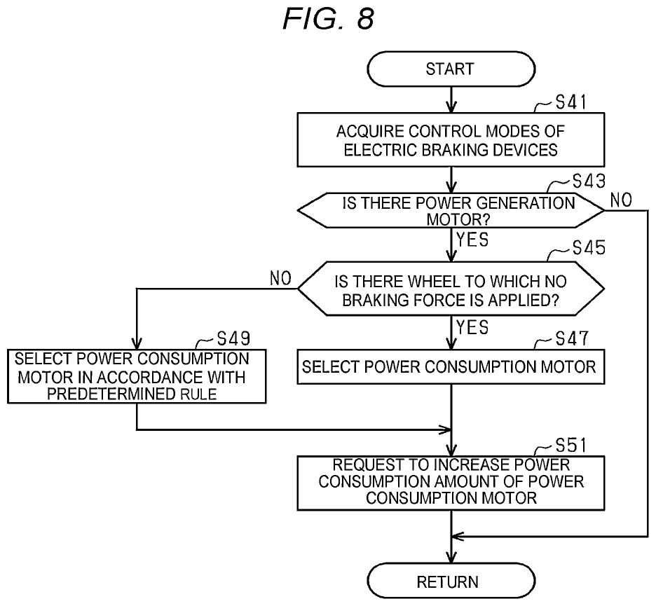

The power consumption amount increase request processing executed in the embodiment will be described with reference to FIG. 8. FIG. 8 is a flowchart illustrating the power consumption amount increase request processing. A control program corresponding to the power consumption amount increase request processing is stored in the storage unit 32 of the integrated control device 30A. The control program is repeatedly executed at predetermined intervals by the execution unit 31 of the integrated control device 30A.

In step S41, the execution unit 31 acquires control modes of the plurality of electric braking devices 21A, 23, and 24. Specifically, the execution unit 31 acquires the control modes based on transition of the electric motors obtained by acquiring a control variable of the electric motors of the electric braking devices from the control units 80A, 83, and 84 at predetermined intervals.

In step S43, the execution unit 31 functions as the determination unit 101A to determine whether there is a power generation motor that is an electric motor determined as generating regenerative power among the plurality of electric motors 71A and 72. If there is a power generation motor (S43: YES), the execution unit 31 proceeds to the processing of step S45, and if there is no power generation motor (S43: NO), the execution unit 31 temporarily ends the current processing.

In step S45, the execution unit 31 functions as the selection unit 104A to determine whether there is a wheel to which no braking force is applied by the electric braking device. If there is a wheel to which no braking force is applied by the electric braking device (S45: YES), the execution unit 31 proceeds to the processing of step S47, and if there is no wheel to which no braking force is applied by the electric braking device (S45: NO), the execution unit 31 proceeds to the processing of step S49. In the embodiment, a wheel to which no braking force is applied by the electric braking device is referred to as a “non-braking wheel”.

In step S47, the execution unit 31 functions as the selection unit 104A to select the electric motor of the electric braking device corresponding to the non-braking wheel as the power consumption motor. Then, the execution unit 31 proceeds to the processing of step S51.

In step S49, the execution unit 31 functions as the selection unit 104A to select the power consumption motor in accordance with the predetermined rule. Then, the execution unit 31 proceeds to the processing of step S51.

In step S51, the execution unit 31 functions as the request unit 102A to request the control unit corresponding to the electric motor selected as the power consumption motor in step S47 or step S49 to increase the power consumption amount of the electric motor. Thereafter, the execution unit 31 temporarily ends the current processing.

### <Operations and Effects of Embodiment>

(B3) The operations and effects in a case where a braking force is applied to both the front wheels 11 and 12 by the front wheel electric braking device 21A based on a command from the integrated control device 30 will be described.

For example, when the control mode of the front wheel electric braking device 21A is switched, the integrated control device 30A determines that regenerative power is generated by the electric motor 71A of the front wheel electric braking device 21A. That is, the electric motor 71A corresponds to the power generation motor. The electric motor 72 other than the electric motor 71A corresponding to the power generation motor is connected to the power supply circuit 26A common to the electric motor 71A. Therefore, it is requested to increase the power consumption amount of at least one of the two electric motors 72.

Specifically, it is determined whether there is a rear wheel electric braking device that does not apply a braking force to the rear wheel among the two rear wheel electric braking devices 23 and 24. When none of the two rear wheel electric braking devices 23 and 24 applies a braking force to the rear wheel, both of the two electric motors 72 are selected as the power consumption motor. When only one rear wheel electric braking device of the two rear wheel electric braking devices 23 and 24 does not apply a braking force to the rear wheel, only the electric motor 72 of the one rear wheel electric braking device is selected as the power consumption motor. In this case, the electric motor 72 of the rear wheel electric braking device that applies a braking force to the rear wheel is not selected as the power consumption motor. When both of the two rear wheel electric braking devices 23 and 24 apply a braking force to the rear wheel, at least one of the two electric motors 72 is selected as the power consumption motor in accordance with the predetermined rule.

When the power consumption motor is selected in this manner, the integrated control device 30A requests the control unit corresponding to the electric motor 72 selected as the power consumption motor to increase the power consumption amount of the electric motor 72. For example, when the electric motor 72 of the rear wheel electric braking device 23 is selected as the power consumption motor, the control unit 83 of the rear wheel electric braking device 23 is requested to increase the power consumption amount of the electric motor 72.

When an increase in the power consumption amount of the electric motor 72 is requested by the integrated control device 30A, the control units 82 and 83 drive the electric motor 72 so that the power consumption amount of the electric motor 72 corresponding thereto is increased. For example, when the operating state of the rear wheel electric braking device is a contact state, the control units 82 and 83 perform the d-axis current increase control. Further, for example, when the operating state of the rear wheel electric braking device is the separated state, the control units 82 and 83 perform the electric motor forced drive control. Accordingly, at least a part of regenerative power generated by the electric motor 71A of the front wheel electric braking device 21A can be consumed by the electric motor 72 other than the electric motor 71A.

The operation in a case where the electric motor other than the electric motor 71A of the front wheel electric braking device 21A is the power generation motor is substantially the same as in the case of the above (B3), and thus a description thereof is omitted here.

Further, in the embodiment, the same effects as (1) of the first embodiment can be obtained.

### (Modifications)

The plurality of embodiments described above can be modified as follows. The plurality of embodiments described above and the following modifications can be implemented in combination with each other within a technically consistent range.
In the plurality of embodiments, the determination unit 101 may determine that regenerative power is generated by the electric motor, based on a rotation direction of the electric motor and a torque direction in addition to the switching of the control mode or instead of the switching of the control mode. Specifically, the determination unit 101 may determine that a regenerative braking force is generated by the electric motor when the rotation direction of the electric motor is opposite to the torque direction. In this case, it is sufficient to derive the rotation direction of the electric motor from, for example, an output signal of a rotation angle sensor that detects a rotation angle of the electric motor. It is sufficient to derive the torque direction of the electric motor from, for example, a torque command value.
In the second embodiment, it is sufficient that the determination unit 101A determines whether regenerative power is generated by at least one of the plurality of electric motors 71A and 72. For example, if the determination unit 101A determines whether regenerative power is generated by the plurality of electric motors 72, the determination unit 101A may not determine whether regenerative power is generated by the electric motor 71A. For example, if the determination unit 101A determines whether regenerative power is generated by the electric motor 71A, the determination unit 101A may not determine whether regenerative power is generated by the electric motors 72.
In the second embodiment, the selection unit 104A may select all electric motors other than the power consumption motor as the power generation motor among the plurality of electric motors 71A and 72.
Although the integrated control device 30A functions as the determination unit 101A in the second embodiment, the present disclosure is not limited thereto. That is, each of the plurality of control units 80A, 83, and 84 may function as the determination unit. In this case, each of the plurality of control units 80A, 83, and 84 may function as the selection unit, or each of the plurality of control units 80A, 83, and 84 may function as the selection unit and the request unit.
Although each of the plurality of control units 81 to 84 functions as the determination unit 101 and the request unit 102 in the first embodiment, the present disclosure is not limited thereto. For example, the integrated control device 30 may function as the determination unit and the request unit.
In the first embodiment, the plurality of control units 81 to 84 may not function as the request unit 102. In this case, when it is determined that regenerative power is generated by the electric motor, the determination unit 101 may transmit the determination result to another control unit, and the other control unit may perform the d-axis current increase control and the electric motor forced drive control.
In the plurality of embodiments described above, when increasing the power consumption amount of the electric motor, the d-axis current increase control may be performed regardless of whether the operating state of the electric braking device is the separated state or the contact state.
In the second embodiment, the brake system may include the two front wheel electric braking devices 21 and 22 illustrated in FIG. 1 instead of the front wheel electric braking device 21A.
In the first embodiment, the front wheel electric braking device that applies a braking force to the front wheels 11 and 12 may be an electric braking device of a dry type like the rear wheel electric braking devices 23 and 24.
In the plurality of embodiments described above, the rear wheel electric braking device that applies a braking force to the rear wheels 13 and 14 may be an electric braking device of a wet type like the front wheel electric braking devices 21 and 22.
Although the first power supply circuit 26 and the second power supply circuit 27 are provided as the power supply circuit in the first embodiment, one power supply circuit may be provided. In this case, power is supplied from one power supply circuit to the plurality of electric braking devices 21 to 24. Therefore, the execution units 91 of the plurality of control units 81 to 84 may function as selection units. That is, the execution unit 91 executes processing equivalent to the power consumption amount increase request processing illustrated in FIG. 8.
In the first embodiment, the rear wheel electric braking device 23 and the rear wheel electric braking device 24 may be connected to the common first power supply circuit, and the front wheel electric braking device 21 and the front wheel electric braking device 22 may be connected to the common second power supply circuit.
Although the rear wheel electric braking device 23 is provided with the control unit 83 and the rear wheel electric braking device 24 is provided with the control unit 84 in the plurality of embodiments described above, the rear wheel electric braking device 23 and the rear wheel electric braking device 24 may be controlled by a common control unit.
Although the front wheel electric braking device 21 is provided with the control unit 81 and the front wheel electric braking device 22 is provided with the control unit 82 in the first embodiment, the front wheel electric braking device 21 and the front wheel electric braking device 22 may be controlled by a common control unit.
Although the control unit is provided for each electric braking device and the control unit controls the electric motor of the corresponding electric braking device in the plurality of embodiments described above, the present disclosure is not limited thereto. For example, the electric braking device may not include the control unit. In this case, the integrated control devices 30 and 30A control the electric motors of the plurality of electric braking devices.
The integrated control devices 30 and 30A and the control units 81 to 84 and 80A may be implemented as a circuit including one or more processors that operate in accordance with a computer program, one or more dedicated hardware circuits such as dedicated hardware that performs at least some processing of various types of processing, or a combination thereof. Examples of dedicated hardware include an ASIC that is an application-specific integrated circuit. The processor includes a CPU and a memory, such as a RAM and an ROM, and the memory stores program codes or commands configured to cause the CPU to perform processing. The memory, that is, a storage medium includes any available medium that can be accessed by a general-purpose or dedicated computer.

### (Other Technical Ideas)

Technical ideas that can be grasped from the embodiments and the modifications will be described below.
(a) As the control mode of the first electric braking device, a decrease mode of decreasing a braking force applied to the wheel, a holding mode of holding the braking force, and an increase mode of increasing the braking force are preferably prepared, and the determination unit preferably determines that regenerative power is generated by the first electric motor when the control mode of the first electric braking device is switched.
(b) The determination unit preferably determines that regenerative power is generated by the first electric motor when any one of the switching of the control mode of the first electric braking device from the decrease mode to the holding mode, the switching of the control mode of the first electric braking device from the decrease mode to the increase mode, the switching of the control mode of the first electric braking device from the increase mode to the holding mode, and the switching of the control mode of the first electric braking device from the increase mode to the decrease mode is established.
(c) The determination unit preferably determines that regenerative power is generated by the electric motor of the electric braking device when any one of the switching of the control mode of the electric braking device from the decrease mode to the holding mode, the switching of the control mode of the electric braking device from the decrease mode to the increase mode, the switching of the control mode of the electric braking device from the increase mode to the holding mode, and the switching of the control mode of the electric braking device from the increase mode to the decrease mode is established.

The expression “at least one” used in the present specification means “one or more” desired options. As an example, the expression “at least one” used in the present specification means “only one option” or “both of two options” when the number of options is two. As another example, the expression “at least one” used in the present specification means “only one option” or “any combination of two or more options” when the number of options is three or more.

1. A brake system to be applied to a vehicle including a first wheel and a second wheel as wheels, the brake system comprising:
a first electric braking device configured to apply a braking force to the first wheel; and
a second electric braking device configured to apply a braking force to the second wheel, wherein
the first electric braking device and the second electric braking device apply a braking force to the wheel by bringing a friction portion into contact with a friction-receiving portion, and each include an actuator configured to transition an operating state of the electric braking device between a contact state in which the friction portion is in contact with the friction-receiving portion and a separated state in which the friction portion is separated from the friction-receiving portion,
a first electric motor that is a power source of the actuator of the first electric braking device and a second electric motor that is a power source of the actuator of the second electric braking device are connected to a common power supply circuit,
a determination unit configured to determine whether regenerative power is generated by the first electric motor, and
a control unit configured to increase a power consumption amount of the second electric motor when the determination unit determines that regenerative power is generated by the first electric motor.

2. The brake system according to claim 1, wherein
the control unit is configured to
control a current of a d-axis component and a current of a q-axis component to the second electric motor by vector control, and
increase the power consumption amount of the second electric motor by increasing an absolute value of the current of the d-axis component in the vector control when the determination unit determines that regenerative power is generated by the first electric motor.

3. The brake system according to claim 1, wherein
when the determination unit determines that regenerative power is generated by the first electric motor and the operating state of the second electric braking device is the separated state, the control unit increases the power consumption amount of the second electric motor by driving the second electric motor in a range in which the operating state of the second electric braking device is maintained in the separated state.

4. The brake system according to claim 1, further comprising:
a first control device corresponding to the first electric braking device; and
a second control device corresponding to the second electric braking device, wherein
the first control device includes
the determination unit, and
a request unit configured to request the control unit to increase the power consumption amount of the second electric motor when the determination unit determines that regenerative power is generated by the first electric motor, and
the second control device includes
the control unit,
the control unit being configured to increase the power consumption amount of the second electric motor when requested by the request unit to increase the power consumption amount of the second electric motor.

5. A brake system to be applied to a vehicle including three or more wheels, the brake system comprising:
three or more electric braking devices corresponding to the three or more wheels, wherein
the three or more electric braking devices apply a braking force to the wheel by bringing a friction portion into contact with a friction-receiving portion, and each include an actuator configured to transition an operating state of the electric braking device between a contact state in which the friction portion is in contact with the friction-receiving portion and a separated state in which the friction portion is separated from the friction-receiving portion, an electric motor that is a power source of the three or more actuators is connected to a common power supply circuit,
a determination unit configured to determine whether regenerative power is generated by at least one of the three or more electric motors,
a selection unit configured to select a power consumption motor that is the electric motor consuming regenerative power generated by a power generation motor that is the electric motor determined by the determination unit as generating regenerative power, from among the electric motors other than the power generation motor based on an operating state of the electric braking device including the electric motor other than the power generation motor, and
a control unit configured to increase the power consumption amount of the power consumption motor selected by the selection unit when the determination unit determines that regenerative power is generated by any one of the three or more electric motors.

6. The brake system according to claim 2, wherein
when the determination unit determines that regenerative power is generated by the first electric motor and the operating state of the second electric braking device is the separated state, the control unit increases the power consumption amount of the second electric motor by driving the second electric motor in a range in which the operating state of the second electric braking device is maintained in the separated state.

7. The brake system according to claim 2, further comprising:
a first control device corresponding to the first electric braking device; and
a second control device corresponding to the second electric braking device, wherein
the first control device includes
the determination unit, and
a request unit configured to request the control unit to increase the power consumption amount of the second electric motor when the determination unit determines that regenerative power is generated by the first electric motor, and the second control device includes
the control unit,
the control unit being configured to increase the power consumption amount of the second electric motor when requested by the request unit to increase the power consumption amount of the second electric motor.

8. The brake system according to claim 3, further comprising:
a first control device corresponding to the first electric braking device; and
a second control device corresponding to the second electric braking device, wherein
the first control device includes
the determination unit, and
a request unit configured to request the control unit to increase the power consumption amount of the second electric motor when the determination unit determines that regenerative power is generated by the first electric motor, and the second control device includes
the control unit,
the control unit being configured to increase the power consumption amount of the second electric motor when requested by the request unit to increase the power consumption amount of the second electric motor.
